(19) United States
(12) Patent Application Publication
(10) Pub. No.: US 2013/0209342 A1
(43) Pub. Date: Aug. 15, 2013

(54) PROCESS FOR REMOVING NITROUS OXIDE FROM A GAS STREAM

(71) Applicants: Christos Odyssea Angelides, Houston, TX (US); Bradley Douglas Morello, Houston, TX (US)

(72) Inventors: Christos Odyssea Angelides, Houston, TX (US); Bradley Douglas Morello, Houston, TX (US)

(21) Appl. No.: 13/698,377

(22) PCT Filed: May 17, 2011
(86) PCT No.: PCT/US11/36794

§ 371 Date: Dec. 13, 2012

Related U.S. Application Data
(60) Provisional application No. 61/346,071, filed on May 19, 2010.

(51) Int. Cl. B01D 53/56

(52) U.S. Cl. CPC B01D 53/565
USPC 423/239.2; 423/235

(57) ABSTRACT

A process for the removal of nitrous oxide from a gas stream having a contaminating concentration of nitrous oxide to provide a gas stream with a significantly reduced concentration of nitrous oxide is described. The process includes the use of a process system having multiple N₂O decomposition reactors each of which contain a nitrous oxide decomposition catalyst and heat transfer units each of which contain a heat sink media that are operatively connected in a particular order and arrangement for use in the process. The gas stream is passed to the process system that is operated for a period of time in a specific operating mode followed by the stopping of such operation and reversal of the process flow. These steps may be repeatedly taken in order to provide for an enhanced energy recovery efficiency for a given nitrous oxide destruction removal efficiency.

### FIELD OF INVENTION

This invention relates to a process for the removal of nitrous oxide (N₂O) that is contained at a contaminating concentration in a gas stream.

### BACKGROUND

Nitrous oxide (N₂O), commonly known as laughing gas, can be a product of the combustion of carbon-containing materials, such as hydrocarbons, and nitrogen bearing compounds, such as ammonia (NH₃). Other combustion products include the nitrogen oxides of NO and NO₂, both together may be referred to as NOₓ. Nitrous oxide is considered to be a greater contributor to the greenhouse effect and global warming than certain other greenhouse gases such as carbon dioxide (CO₂), and it would be desirable to have a process that is able to economically remove contaminating concentrations of nitrous oxide contained in combustion gases that are released into the atmosphere.

The prior art generally has been focused more on the reduction of nitrogen oxides that are contained in combustion gases rather than on the removal of nitrous oxide. One process used for the removal of NOₓ from gas streams is the selective catalytic reduction (SCR) process. One version of this process is disclosed in U.S. Pat. No. 7,294,321. In this selective catalytic reduction process, a combustion gas that contains a concentration of NOₓ and ammonia (NH₃), which is typically added to the combustion gas as a reactant, is contacted with a catalyst that promotes the reduction reaction in which the NOₓ reacts with ammonia and oxygen to yield nitrogen and water.

Disclosed in U.S. Pat. No. 7,459,135 is a catalyst used for the catalytic reduction of NO_{R}. This catalyst comprises a palladium-containing zeolite, wherein the zeolite also comprises scandium or yttrium or a lanthanide or combinations thereof. The teachings of U.S. Pat. No. 7,459,135 are not concerned, however, with the catalytic decomposition of nitrous oxide. One process that does, on the other hand, involve the catalytic decomposition of nitrous oxide contained in a gas is the process disclosed in U.S. Pat. No. 6,143,262. In this process, a gas that contains nitrous oxide is contacted with a catalyst that comprises mainly tin oxide, but it further may include cobalt as a co-catalyst.

Another process for the catalytic decomposition of nitrous oxide is disclosed in US 2008/044334. This publication teaches a catalyst that is used for the catalytic decomposition of nitrous oxide (N₂O) to yield nitrogen (N₂) and oxygen (O₂). The broadly disclosed catalyst of US 2008/044334 comprises a zeolite that has been loaded with a first noble metal and a second transition metal. The first metal is selected from the group consisting of ruthenium (Ru), rhodium (Rh), osmium (Os), and iridium (Ir), and the second metal is selected from the group consisting of iron (Fe), cobalt (Co), and nickel (Ni).

Due to nitrous oxide being a greenhouse gas having a global warming potential that is significantly greater than certain other greenhouse gases, it is desirable to have a process for the removal of nitrous oxide from gas streams that have high concentrations of nitrous oxide and are released into the atmosphere. It is further desirable for such a process to achieve the removal of nitrous oxide in a cost-effective, thermally efficient manner.

### SUMMARY OF INVENTION

Thus, provided is a process for the removal of nitrous oxide (N₂O) from a gas stream containing a contaminating concentration of nitrous oxide, wherein said process comprises passing said gas stream through a heat transfer zone containing a heat transfer material of a high heat capacity whereby heat is transferred from said heat transfer material to said gas stream to thereby provide a heated gas stream; passing said heated gas stream to a reaction zone containing a N₂O decomposition catalyst that provides for the decomposition of nitrous oxide and yielding therefrom a gas stream having a reduced concentration of nitrous oxide; passing said gas stream having said reduced concentration of nitrous oxide to a second reaction zone containing a second N2O decomposition catalyst wherein nitrous oxide is decomposed to yield a gas stream having a further reduced concentration of nitrous oxide; and passing said gas stream having said further reduced concentration of nitrous oxide to a second heat transfer zone containing a second heat transfer material of a second high heat capacity whereby heat is transferred from said gas stream having said further reduced concentration of nitrous oxide to said second heat transfer material to thereby provide a cooled gas stream.

### BRIEF DESCRIPTION OF DRAWING

FIG. 1 is a schematic representation of the process flow and system arrangement of the inventive process for the removal of nitrous oxide from a gas stream that contains a contaminating concentration of nitrous oxide.

### DETAILED DESCRIPTION

The inventive process is a highly energy efficient method of removing nitrous oxide from a gas stream that has a contaminating or high concentration of nitrous oxide. Nitrous oxide is a greenhouse gas that has an extremely high global warming potential and contributes to the depletion of the ozone layer of the earth's atmosphere. The inventive process provides for a low required energy input for a given amount of greenhouse gas, i.e., nitrous oxide, that is removed from a gas stream that contains the nitrous oxide, and the process provides for a high percentage of total greenhouse gas removal including the removal of both nitrous oxide and carbon dioxide.

Nitrous oxide can be generated during the combustion of various types of carbonaceous materials and nitrogen bearing compounds by various combustion means such as incinerators, furnaces, boilers, fired heaters, combustion engines and other combustion devices. The carbonaceous and nitrogen bearing materials that may be combusted can include, for example, wood and other cellulosic materials, coal, fuel oil and other petroleum or mineral derived fuels, fuel gas and other gases, and other carbonaceous materials, and nitrogen bearing materials, such as, ammonia and nitric acid. It is contemplated that the more common combustion material of the inventive process will be ammonia, which may be generated from such sources as either in the production, or the use, or the destruction of nitric acid, adipic acid, glyoxal, and glyoxylic acid. Typically, ammonia is burned in a burner that provides for the mixing of air with the gas to give a combustion mixture that, upon its combustion, yields combustion gases. These combustion gases often contain undesirable combustion products such as carbon monoxide, nitrogen oxide, and nitrous oxide.

The combustion of the carbonaceous material provides for a gas stream that can comprise a contaminating concentration of nitrous oxide. The gas stream that is to be treated in the inventive process for the removal of nitrous oxide will typically have a contaminating concentration of nitrous oxide that, generally, is in the range of from about 100 ppmv to about 600,000 ppmv (60 vol. %). More typically, however, the nitrous oxide concentration in the gas stream will be in the range of from 100 ppmv to 10,000 ppmv (1 vol. %), and, most typically, it is in the range of from 100 ppmv to 5,000 ppmv.

Other components of the combustion gas stream can include nitrogen, which source may be contained in nitrogen bearing compounds such as ammonia and nitric acid and to some extent the air used in the combustion of the carbonaceous material, carbon dioxide and water vapor. The amount of carbon dioxide in the combustion gas stream can typically be in the range of from about 5 vol. % to about 20 vol. %, and the amount of water vapor in the combustion stream can typically be in the range of from about 5 vol. % to 20 vol. %. The molecular nitrogen in the combustion gas stream can be in the range of from 50 vol. % to 80 vol. %. If excess amounts of oxygen are used in the combustion of the carbonaceous material, then molecular oxygen can be present in the combustion gas stream, as well. Normally, it is not desirable to use an excess amount of oxygen when burning carbonaceous materials, but when excess oxygen is used in the combustion, typically, oxygen can be present in the combustion gas stream at a concentration in the range of upwardly to about 4 vol. %, or higher, such as in the range of from 0.1 vol. % to 3.5 vol. %.

Other components of the combustion gas stream may include NOₓ, CO, and SOₓ. The NOₓ can be present in the combustion gas stream at a concentration in the range of from about 1 ppmv to about 10,000 ppmv (1 vol. %). The carbon monoxide may be present at a concentration in the range of from 1 ppmv to 2,000 ppmv or more.

The inventive process provides for a high heat recovery by the use of a multiple or plurality of heat transfer zones and a multiple or plurality of reaction zones. These heat transfer zones and reaction zones are operatively connected in a particular arrangement or order so as to give a process system that may be operated in a specific manner and at non-equilibrium conditions to give a high heat recovery across the process system. The process and system also provide for a high nitrous oxide destruction removal efficiency along with the high heat recovery efficiency.

Each of the reaction zones of the process system is defined by structure, and contained within each of such reaction zones is a N₂O decomposition catalyst. The N₂O decomposition catalyst provides for the catalytic decomposition or conversion of nitrous oxide to yield nitrogen and oxygen. Any suitable catalyst that is capable of being used under the conditions of the process and which catalyzes the nitrous oxide decomposition reaction may be used in the reaction zones of the process system.

Catalysts that are particularly useful in the inventive process include those disclosed in US Patent Publication No. 2008/0044334, which publication is hereby incorporated herein by reference. Such suitable catalysts include those as are described in detail in US 2008/0044334 and that, generally, comprise a zeolite loaded with a noble metal selected from the group consisting of ruthenium, rhodium, silver, rhenium, osmium, iridium, platinum and gold, and loaded with a transition metal selected from the group consisting of vanadium, chromium, manganese, iron, cobalt, nickel and copper.

Each of the heat transfer zones of the process system is defined by structure, and contained within each of such heat transfer zones is a heat transfer material or media. The heat transfer material comprises a heat sink media that provides for the transfer of thermal energy (heat) to and from the gas stream of the process. When the temperature of the gas stream is greater than the temperature of the heat transfer material, then heat flows from the gas stream to the heat transfer material to thereby cool the gas stream and to provide a cooled gas stream. When the temperature of the heat transfer material is greater than the temperature of the gas stream, then heat is transferred from the heat transfer material to the gas stream to thereby heat the gas stream and to provide a heated gas stream.

The heat sink media of the heat transfer material may be selected from a wide variety of materials that have the required thermal conductivity, heat capacity and other properties necessary for a good heat sink media and for use in the inventive process. It is especially desirable for the heat transfer material to have a relatively high thermal conductivity and heat capacity. The heat capacity of the heat transfer material is typically in the range of from about 750 to 1300 kJ/(g·K), and, more specifically, in the range of from 850 to 1200 kJ/(g·K). The thermal conductivity of the heat transfer material is typically in the range of from about 1 to 3 W/(m·K), and, more specifically, in the range of from 1.5 to 2.6 W/(m·K).

Ceramic materials are particularly good for the heat sink application. These ceramic materials may include such compounds as alumina, silica, titania, zirconia, beryllium oxide, aluminum nitride, and other suitable materials including mixtures of the aforementioned compounds.

The ceramic heat sink media may also include other compounds, usually in trace concentrations, such as iron oxide (Fe₂O₃), calcium oxide (CaO), magnesium oxide (MgO), sodium oxide (Na₂O), potassium oxide (K₂O) and combinations thereof.

Particularly desirable ceramic materials for use as the heat sink media of the inventive process include those selected from the group consisting of alumina, silica and combinations thereof. Concerning these particularly desirable heat sink media, when the heat sink media comprises predominantly alumina, the alumina is present in amounts in the range of from 10 wt. % to 99 or greater wt. %. When the heat sink media comprises predominantly silica, the silica is present in amounts in the range of from 10 wt. % to 99 or greater wt. %. When the heat sink media includes a combination of both alumina and silica, the alumina is present in the heat sink media in an amount in the range of from 1 to 99 wt. %, and the silica is present in an amount in the range of from 1 to 99 wt. %. These weight percents are all based on the total weight of the heat sink media.

The heat sink media is preferably a structured or engineered or shaped material of a particular design that may provide for certain features or benefits such as, for example, a reduced or lowered pressure drop across a bed of the heat sink media, or a reduction in fouling or plugging of the bed of heat sink media, or improved mechanical integrity of the heat sink media or other advantages. Examples of the shapes or structures of the heat sink media may include shapes such as balls, cylinders, saddles, tubes, hollow cylinders, wheels, and a variety of other shapes that are typically used for such media. Commercially available examples of ceramic heat transfer media suitable for use as the heat transfer material of the inventive process include those being offered for sale by Saint-Gobain NorPro and having the product identifications of Norton™ Saddles, Ty-Pak® Heat Transfer Media, Snowflake™ Heat Transfer Media, AF38™ Media, HexPak™ Heat Transfer Media, and others.

As already noted, the inventive process provides for the removal of nitrous oxide from a gas stream that contains a contaminating concentration of nitrous oxide. Typically, the gas stream of the process is a combustion flue gas stream that includes combustion gases and further includes a concentration of nitrous oxide, and it also may further include a concentration of NOₓ compounds. It is not, however, the particular objective of the inventive process to remove the NOₓ compounds from the gas stream even though their removal may result.

In the typical selective catalytic reduction process used for the removal of NOₓ from combustion flue gas streams the presence of a reactant or reductant such as anhydrous ammonia, aqueous ammonia or urea is required along with the contacting of the gas stream with a reduction catalyst in order to convert the NO_{R}. In the inventive process, on the other hand, no reductant need be present in the nitrous oxide containing gas stream that is contacted with the N₂O decomposition catalyst whereby nitrous oxide decomposition occurs. It is even preferred for the gas stream to have a substantial absence of a concentration of ammonia or urea, or both; and, thus, the gas stream of the inventive process should have a concentration of ammonia or urea, or both, or less than about 10,000 ppmv, preferably, less than 1,000 ppmv, and most preferably, less than 10 ppmv.

It is also a desirable aspect of the inventive process for the gas stream to have a low concentration of hydrocarbon compounds. It is, thus, desirable for the hydrocarbon concentration of the gas stream of the inventive process to contain less than 200 ppmv, preferably, less than 50 ppmv, and more preferably, less than 20 ppmv of the total gas stream. The hydrocarbons will generally be those that are normally gaseous at standard pressure and temperature conditions and can include methane, ethane, propane and butane.

In the inventive process, a gas stream that has a contaminating concentration of nitrous oxide is passed and introduced into a heat transfer zone. Contained within the heat transfer zone is a heat transfer material. The properties and composition of the heat transfer material are as described elsewhere herein. The gas stream is introduced into the heat transfer zone wherein it passes over or is contacted with the heat transfer material that is contained in the heat transfer zone and whereby thermal or heat energy is exchanged between the heat transfer material and the gas stream. Prior to the initial step of the process, the heat transfer material will have been heated either by way of a start-up procedure to raise its temperature to a desired starting temperature or by passing a heated gas stream through the heat transfer zone and over the heat transfer material.

In the initial step of the process, the heat transfer material of the heat transfer zone has an initial temperature greater than the temperature of the gas stream containing the contaminating concentration of nitrous oxide and, as the gas stream passes through the heat transfer zone, thermal energy is transferred from the heat transfer material to the gas stream. A heated gas stream is then yielded from the heat transfer zone. Typically, in this step, the heat transfer material will start at a temperature in the range of from about 400° C. to about 700° C. and the temperature of the gas stream being introduced into the heat transfer zone is in the range of from about 10° C. to about 400° C. Over a time period, the temperature of the heat transfer material will decline as its thermal energy is transferred to the gas stream that passes through the heat transfer zone.

The heated gas stream yielded from the heat transfer zone is passed to and introduced into a reaction zone. Contained within the reaction zone is a N₂O decomposition catalyst. This N₂O decomposition catalyst has a composition as is described elsewhere herein. The heated gas stream has a temperature that allows for the nitrous oxide decomposition reaction to occur when it is contacted with the N₂O decomposition catalyst of the reaction zone. The temperature of the heated gas stream, thus, should generally be in the range of from 400° C. to 700° C.

Within the reaction zone, the reaction conditions are such as to suitably provide for the decomposition of at least a portion of the nitrous oxide contained in the heated gas stream to nitrogen and oxygen, and, then, a gas stream having a reduced concentration of nitrous oxide is yielded from the reaction zone. Typically, in this step, due to the exothermic nature of the nitrous oxide decomposition reaction, the gas stream having a reduced concentration of nitrous oxide will have somewhat of an elevated temperature above that of the heated gas stream being introduced into the reaction zone. The exotherm, which is the temperature difference between the temperature of the heated gas stream that passes from the heat transfer zone and introduced into the reaction zone and the temperature of the gas stream having a reduced concentration of nitrous oxide yielded from the reaction zone, may be in the range of from a minimal temperature increase to an increase of 200° C. More typically, however, the exotherm is in the range of from 5° C. to 200° C. and, most typically, it is in the range of from 10° C. to 45° C.

The gas stream having the reduced concentration of nitrous oxide then passes from the reaction zone to a second reaction zone. Contained within the second reaction zone is a second N₂O decomposition catalyst. This second N₂O decomposition catalyst has a composition and properties as earlier described herein. The gas stream having the reduced concentration of nitrous oxide is introduced into the second reaction zone wherein it is contacted with the second N₂O decomposition catalyst under suitable nitrous oxide decomposition reaction conditions.

The gas stream having the reduced concentration of nitrous oxide that is introduced into the second reaction zone may have a temperature approximating its temperature when yielded from the reaction zone, or, optionally, its temperature may be further increased by introducing additional heat energy into it prior to passing the gas stream having the reduced concentration of nitrous oxide to the second reaction zone. The temperature of the gas stream having the reduced concentration of nitrous oxide that is introduced into the second reaction zone will, thus, have a temperature in the range of from about 400° C. to about 700° C. More typically, the temperature can be in the range of from 450° C. to 550° C.

Within the second reaction zone the gas stream having the reduced concentration of nitrous oxide is passed over and contacted with the second N₂O decomposition catalyst. The reaction conditions within the second reaction zone are such as to provide for the decomposition of at least a portion of the nitrous oxide contained in the gas stream having the reduced concentration of nitrous oxide to nitrogen and oxygen. A gas stream having a further reduced concentration of nitrous oxide is then yielded from the second reaction zone.

As in the step of passing the heated gas stream to the reaction zone, in this step, the nitrous oxide decomposition reaction is exothermic, and, as a result, may provide a temperature increase across the second reaction zone with the temperature of the yielded gas stream having the further reduced concentration of nitrous oxide being elevated over the temperature of the introduced gas stream having the reduced concentration of nitrous oxide. This temperature increase may be in the range of from a minimal temperature increase up to 200° C. or higher. A more typical temperature increase is in the range of from 2° C. to 100° C. or from 5° C. to 40° C.

The gas stream having the further reduced concentration of nitrous oxide then passes from the second reaction zone to a second heat transfer zone that contains a second heat transfer material having a second heat capacity. The temperature of second heat transfer material is less than the temperature of the gas stream having the further reduced concentration of nitrous oxide, and, as a result, heat energy is transferred from the gas stream having the further reduced concentration of nitrous oxide to the second heat transfer material as it passes through the second heat transfer zone. A cooled gas stream is then yielded from the second heat transfer zone. Typically, in this step, the second heat transfer material will start at a temperature in the range of from about 400° C. to about 700° C. Over a time period, the temperature of the second heat transfer material will decline as its thermal energy is transferred to the gas stream having the further reduced concentration of nitrous oxide as it passes through the second heat transfer zone. The cooled gas stream passing from the second heat transfer zone will have a temperature approaching that of the gas stream that is introduced into the heat transfer zone of the process system.

The cooled gas stream may then pass from the second heat transfer zone and into a flue stack or downstream for further processing. The concentration of nitrous oxide is significantly lower than the contaminating concentration of nitrous oxide of the gas stream initially being passed to the heat transfer zone of the process system.

A measure of the amount of nitrous oxide destroyed by the inventive process may be reflected by the overall nitrous oxide destruction removal efficiency percentage of the inventive process. This value is calculated by the difference in the nitrous oxide contained in the gas stream having a contaminating concentration of nitrous oxide that is passed to the process system and the concentration of nitrous oxide contained in the cooled gas stream with the difference being divided by the contaminating concentration of nitrous oxide in the gas stream and the ratio being multiplied by 100. The nitrous oxide destruction removal efficiency (D_{eff}) across the process system may then be represented by the formula, (Cᵢ−Cₒ)/Cᵢ)×100, where Cᵢ is the concentration of nitrous oxide of the gas stream having a contaminating concentration of nitrous oxide, and Cₒ is the concentration of nitrous oxide of the cooled gas stream.

The nitrous oxide destruction removal efficiency across the process system is significant and can be greater than 75%. It is preferred for the nitrous oxide destruction removal efficiency to be greater than 85%, and more preferably, it is greater than 95%. In the most preferred embodiment of the inventive process, the nitrous oxide destruction removal efficiency can be greater than 97.5% and even greater than 99.9%. It is desirable for the concentration of the nitrous oxide in the cooled gas stream to be less than 100 ppmv, and, preferably, it is less than 75 ppmv. More preferably, the concentration of nitrous oxide in the cooled gas stream is less than 50 ppmv.

In order for the inventive process to provide for its high heat recovery efficiency, it is important for the process and system to operate outside of equilibrium or steady state conditions. This requires, in order to keep the process from reaching a state of equilibrium, the gas stream that is initially passed and introduced into heat transfer zone of the system, after a time period, to cease being introduced into the heat transfer zone and having its flow to the process system reversed.

After the flow of the gas stream to the heat transfer zone is stopped, it is then passed to the second heat transfer zone. In this step, the second heat transfer material of the second heat transfer zone, as a result of the previous passing of the gas stream having the further reduced concentration of nitrous oxide over the second heat transfer material, has a temperature that is greater than the temperature of the gas stream containing the contaminating concentration of nitrous oxide. As the gas stream passes over the second heat transfer material and through the second heat transfer zone, heat is transferred from the second heat transfer material to the gas stream. A second heated gas stream is then yielded from the second heat transfer zone with a temperature that is typically in the range of from about 400° C. to about 700° C. Over a time period, the temperature of the second heat transfer material will decline as its thermal energy is transferred to the gas stream that passes through the second heat transfer zone.

The second heated gas stream that is yielded from the second heat transfer zone is passed to and introduced into the second reaction zone wherein at least a portion of the nitrous oxide contained in the second heated gas stream is decomposed to nitrogen and oxygen. Yielded from the second reaction zone is a second gas stream having a second reduced concentration of nitrous oxide. The second gas stream having the second reduced concentration of nitrous oxide is then passed to the reaction zone wherein at least a portion of the nitrous oxide contained therein is decomposed to nitrogen and oxygen. The temperature of the second gas stream having the second reduced concentration of nitrous oxide may, if required, be increased by the introduction of heat energy into it prior to its introduction into the reaction zone.

Yielded from the reaction zone is a second gas stream having a second further reduced concentration of nitrous oxide which is passed to the heat transfer zone. As a result of the previous passing of the gas stream through the heat transfer zone, the heat transfer material therein will have a temperature that is lower than the temperature of the second gas stream having the second further reduced concentration of nitrous oxide. As a result, heat energy is transferred from the second gas stream having the second further reduced concentration of nitrous oxide to the heat transfer material thereby giving a second cooled gas stream that is yielded from the heat transfer zone.

The concentration of nitrous oxide in the second cooled gas stream is low enough to provide across the process system a nitrous oxide destruction removal efficiency that can be greater than 75%. But the preferred nitrous oxide destruction removal efficiency is to be greater than 85%, and more preferred, it is greater than 95%. In the most preferred embodiment of the inventive process, the nitrous oxide destruction removal efficiency can be greater than 97.5% and even greater than 99%. It is desirable for the concentration of the nitrous oxide in the second cooled gas stream to be less than 100 ppmv, and, preferably, it is less than 75 ppmv. More preferably, the concentration of nitrous oxide in the second cooled gas stream is less than 50 ppmv.

After a period of time, the flow of the gas stream being first introduced into the second heat transfer zone of the process system may be stopped with the flow again being reversed and the gas stream again being first introduced into the heat transfer zone. The reversal of the flow of the gas stream to the process system of the process may be, and preferably is, an ongoing aspect of the process; since, in order to obtain the greatest energy recovery efficiency, it is an important feature of the inventive process and the process system to operate outside of an equilibrium or steady state condition.

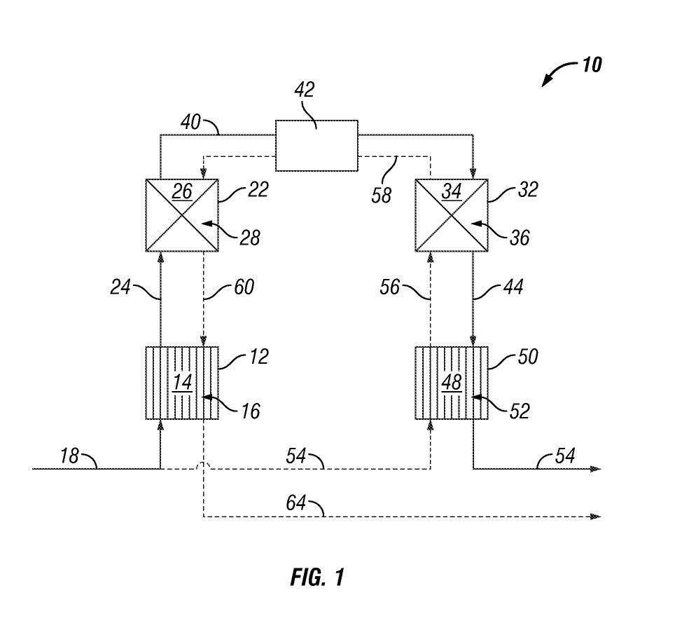

Reference is now made to FIG. 1, which presents a schematic representation of the process system 10 and the process streams of the inventive process for the removal of nitrous oxide from a gas stream having a contaminating concentration of nitrous oxide.

Process system 10 includes a heat transfer unit 12 that defines a heat transfer zone 14. It is understood that the heat transfer unit 12 may include one or more or a plurality of units with each such unit defining a separate heat transfer zone. Contained within heat transfer zone 14 is heat transfer material 16 that has a high heat capacity.

A gas stream having a contaminating concentration of nitrous oxide passes by way of conduit 18 and is introduced into the heat transfer zone 14 of the heat transfer unit 12. In the initial operation of process system 10, the temperature of the heat transfer material 16 is greater than the temperature of the gas stream being introduced into the heat transfer zone 14.

The heat transfer unit 12 is operatively connected and is in fluid flow communication with reaction zone 26 by conduit 24. It is understood that the N₂O decomposition reactor 22 may include one or more or a plurality of reactors each defining a separate N₂O decomposition reaction zone. N2O decomposition reactor 22 defines the reaction zone 26 which contains a N₂O decomposition catalyst 28.

As the gas stream passes through heat transfer zone 14 and is contacted with the heat transfer material 16, thermal or heat energy is transferred from heat transfer material 16 to the gas stream. A heated gas stream is yielded and passes from the heat transfer zone 14 by way of conduit 24 and is introduced into reaction zone 26.

Within reaction zone 26, the gas stream is contacted with N2O decomposition catalyst 28 under N₂O decomposition reaction conditions that are suitable for the promotion of the decomposition of at least a portion of the nitrous oxide contained in the gas stream to nitrogen and oxygen. The N₂O decomposition reactor 22 is operatively connected and is in fluid flow communication with second N₂O decomposition reactor 32 by conduit 40. The second N₂O decomposition reactor 32 defines a second reaction zone 34 which contains a second N₂O decomposition catalyst 36. It is understood that the second N2O decomposition reactor 32 may include one or more or a plurality of reactors each defining a separate N2O decomposition reaction zone.

A gas stream having a reduced concentration of nitrous oxide is yielded from reaction zone 26 and passes by way of conduit 40 to be introduced into second reaction zone 34. The gas stream having the reduced concentration of nitrous oxide passes over and is contacted with the second N₂O decomposition catalyst 36 within second reaction zone 34 which is operated under suitable reaction conditions for the promotion of the decomposition of at least a portion of the nitrous oxide contained in the gas stream.

In an optional embodiment of the invention, heating unit 42 is interposed into conduit 40. Heating unit 42 provides for the introduction of heat energy into the gas stream having the reduced concentration of nitrous oxide in those situations in which incremental thermal energy is needed to be added to the gas stream prior to its introduction into second N₂O decomposition reactor 32.

A gas stream having a further reduced concentration of nitrous oxide is yielded and passes from second reaction zone 34 by way of conduit 44 to be introduced into second heat transfer zone 48. Second heat transfer zone 48 is defined by second heat transfer unit 50 and contains therein a second heat transfer material 52 that has a second heat capacity. Second heat transfer unit 50 is operatively connected and is in fluid flow communication with second N₂O decomposition reactor 32 by conduit 44. It is understood that the second heat transfer unit 50 may include one or more or a plurality of heat transfer units each defining a separate heat transfer zone.

The temperature of the second heat transfer material 52 of the second heat transfer unit 50 is less than the temperature of the gas stream having the further reduced concentration of nitrous oxide and, thus, as the gas stream passes through the second heat transfer zone 48 heat energy is transferred from the gas stream to the second heat transfer material 52 to thereby cool the gas stream. A cooled gas stream is yielded and passes to the downstream from second heat transfer zone 48 by way of conduit 54.

The cooled gas stream will have a concentration of nitrous oxide that is significantly lower than the contaminating concentration of nitrous oxide of the gas stream being introduced into heat transfer zone 14 by way of conduit 18.

After process system 10 has been operated for a period of time in the mode in which the feed gas stream having the contaminating concentration of nitrous oxide is being introduced into heat transfer unit 12, this introduction is stopped and the feed gas flow to process system 10 is reversed. This reversal in gas flow is done by introducing the gas stream by way of conduit 54 into second heat transfer zone 48. In this step, the temperature of second heat transfer material 52 is greater than the temperature of the gas stream being introduced into second heat transfer zone 48. As the gas stream passes through second heat transfer zone 48, heat energy is transferred from the second heat transfer material 52 to the gas stream to provide a second heated gas stream.

The second heated gas stream is yielded from second heat transfer zone 48 and passes by way of conduit 56 to second reaction zone 34. Conduit 56 is operatively connected and provides fluid flow communication between second heat transfer zone 48 and second reaction zone 34. It is understood that conduit 56 is not necessarily, but it may be, a separate or independent conduit from conduit 44, or both conduits 44 and 56 may be the same.

The second heated gas stream is introduced into second reaction zone 34 wherein it passes over and is contacted with second N2O decomposition catalyst 36. The second reaction zone 34 is operated under N₂O decomposition reaction conditions suitable for the decomposition of at least a portion of the nitrous oxide contained within the second heated gas stream and to thereby provide a second gas stream having a second reduced concentration of nitrous oxide. This gas stream is yielded from second reaction zone 34 and passes therefrom by way of conduit 58.

Conduit 58 operatively connects second N2O decomposition reactor 32 and N₂O decomposition reactor 22, and it provides for fluid flow communication between second reaction zone 34 and reaction zone 26. It is understood that conduit 58 is not necessarily, but it may be, a separate or independent conduit from conduit 40 or both conduits 40 and 58 may be the same.

In an optional embodiment of the invention, heating unit 42 is provided and is interposed in conduit 58 or conduit 40, or both conduits, for the introduction of heat energy into the second gas stream having the reduced concentration of nitrous oxide in those situations of which incremental thermal energy is needed to be added to the gas stream prior to its introduction into N₂O decomposition reactor 22.

The second gas stream having the second reduced concentration of nitrous oxide is passed and introduced into reaction zone 26 wherein it passes over and is contacted with the N₂O decomposition catalyst 28. The reaction zone 26 is operated under N₂O decomposition reaction conditions suitable for the decomposition of at least a portion of the nitrous oxide contained within the second gas stream having the second reduced concentration of nitrous oxide and to thereby provide a second gas stream having a second further reduced concentration of nitrous oxide. This gas stream is yielded from reaction zone 26 and passes therefrom by way of conduit 60.

Conduit 60 is operatively connected between N₂O decomposition reactor 22 and heat transfer unit 12, and it provides for fluid flow communication between reaction zone 26 and heat transfer zone 14. The second gas stream having the second further reduced concentration of nitrous oxide passes by way of conduit 60 and is introduced into heat transfer zone 14 wherein it passes over and is contacted with the heat transfer material 16. The temperature of the heat transfer material 16 is less than the temperature of the second gas stream having the second further reduced concentration of nitrous oxide, and, as a result, thermal or heat energy is transferred from the second gas stream having the second further reduced concentration of nitrous oxide to heat transfer material 16 to thereby provide a second cooled gas stream.

The second cooled gas stream is yielded and passes to the downstream from heat transfer zone 14 by way of conduit 64. The second cooled gas stream will have a concentration of nitrous oxide that is significantly lower than the contaminating concentration of nitrous oxide of the gas stream being introduced by way of conduit 54 into heat transfer zone 48.

After a period of time, the flow of the gas stream may be reversed again by ceasing the passing and introduction of the gas stream into second heat transfer zone 48 and then first introducing it into heat transfer zone 14 and repeating the other steps.

In one embodiment, the process system comprises a third reaction zone and heat transfer zone similar to the first two. When only two reaction and heat transfer zones are used, an amount of untreated gas bypasses the reaction zone when the flow is switched. The flow is reversed so the gas flows back out before contacting the catalyst. This untreated gas is not treated by N₂O catalyst before it exits the system. To overcome this, a third reaction and heat transfer reaction zone can be used such that the flow initially passes through the first and second reaction and heat transfer zones and is then switched to pass through the second and third reaction and heat transfer zones. The untreated gas in the first reaction and heat transfer zones can be removed for treating. One of ordinary skill in the art could apply this to any combination of more than two reaction and heat transfer zones.

In one embodiment, the reaction zone also contains a selective catalytic reduction (SCR) catalyst for the removal of NH₃ and NOₓ. NH₃ is already present in the stream and does not need to be added as a reagent as in typical SCR reaction systems.

In another embodiment, the reaction zone also contains catalyst suitable for the reduction of NOₓ, NH₃, SOₓ, VOC, CO, dioxin, etc.

In another embodiment, additional heat may be provided to the system by any means known to one of ordinary skill in the art including gas, electric, and steam.

1. A process for the removal of nitrous oxide (N₂O) from a gas stream containing a contaminating concentration of nitrous oxide, wherein said process comprises:
(a) passing said gas stream through a heat transfer zone containing a heat transfer material of a high heat capacity whereby heat is transferred from said heat transfer material to said gas stream to thereby provide a heated gas stream;
(b) passing said heated gas stream to a reaction zone containing a N2O decomposition catalyst that provides for the decomposition of nitrous oxide and yielding therefrom a gas stream having a reduced concentration of nitrous oxide;
(c) passing said gas stream having said reduced concentration of nitrous oxide to a second reaction zone containing a second N2O decomposition catalyst wherein nitrous oxide is decomposed to yield a gas stream having a further reduced concentration of nitrous oxide; and
(d) passing said gas stream having said further reduced concentration of nitrous oxide to a second heat transfer zone containing a second heat transfer material of a second high heat capacity whereby heat is transferred from said gas stream having said further reduced concentration of nitrous oxide to said second heat transfer material to thereby provide a cooled gas stream.

2. A process as recited in claim 1, further comprising:
(e) after a period of time, reversing the flow of said gas stream by ceasing said passing steps (a), (b), (c), and (d);
(f) passing said gas stream to said second heat transfer zone whereby heat is transferred from said second heat transfer material to said gas stream to thereby provide a second heated gas stream;
(g) passing said second heated gas stream to said second reaction zone wherein nitrous oxide is decomposed and yielding therefrom a second gas stream having a second reduced concentration of nitrous oxide;
(h) passing said second gas stream having said second reduced concentration of nitrous oxide to said reaction zone wherein nitrous oxide is decomposed and yielding therefrom a second gas stream having a second further reduced concentration of nitrous oxide; and
(i) passing said second gas stream having said second further reduced concentration of nitrous oxide to said heat transfer zone whereby heat is transferred from said second gas stream having said second further reduced concentration of nitrous oxide to thereby provide a second cooled gas stream.

3. A process as recited in claim 2, further comprising:
(j) after a period of time, reversing the flow of said gas stream by ceasing said passing steps (f), (g), (h), and (i); and
(k) repeating said passing steps (a), (b), (c), and (d).

4. A process as recited in claim 1, wherein said contaminating concentration of nitrous oxide is in the range of from about 100 ppmv to about 600,000 ppmv, and wherein the nitrous oxide destruction removal efficiency (Deff) for said process is greater than 75%.

5. A process as recited in claim 1, wherein said N2O decomposition catalyst comprises a zeolite loaded with a noble metal selected from the group consisting of ruthenium, rhodium, silver, rhenium, osmium, iridium, platinum and gold, and loaded with a transition metal selected from the group consisting of vanadium, chromium, manganese, iron, cobalt, nickel and copper, and wherein said second N2O decomposition catalyst comprises a zeolite loaded with a noble metal selected from the group consisting of ruthenium, rhodium, silver, rhenium, osmium, iridium, platinum and gold, and loaded with a transition metal selected from the group consisting of vanadium, chromium, manganese, iron, cobalt, nickel and copper.

6. A process as recited in claim 1, wherein said heat transfer material comprises a ceramic material selected from the group consisting of alumina, silica, titania, zirconia, beryllium oxide, aluminum nitride, and mixtures of two or more thereof, and wherein said second heat transfer material comprises a ceramic material selected from the group consisting of alumina, silica, titania, zirconia, beryllium oxide, aluminum nitride, and mixtures of two or more thereof.

7. A process as recited in claim 1, further comprising:
(e) after a period of time, reversing the flow of said gas stream by ceasing said passing steps (a), (b), (c), and (d);
(f) passing said gas stream to said second heat transfer zone whereby heat is transferred from said second heat transfer material to said gas stream to thereby provide a second heated gas stream;
(g) passing said second heated gas stream to said second reaction zone wherein nitrous oxide is decomposed and yielding therefrom a second gas stream having a second reduced concentration of nitrous oxide;
(h) passing said second gas stream having said second reduced concentration of nitrous oxide to a third reaction zone wherein nitrous oxide is decomposed and yielding therefrom a third gas stream having a third further reduced concentration of nitrous oxide; and
(i) passing said third gas stream having said third further reduced concentration of nitrous oxide to the third heat transfer zone whereby heat is transferred from said third gas stream having said third further reduced concentration of nitrous oxide to thereby provide a third cooled gas stream.
